(19) United States
(12) Patent Application Publication
(10) Pub. No.: US 2024/0104748 A1
(43) Pub. Date: Mar. 28, 2024

(54) Image Acquisition with Dynamic Resolution

(71) Applicant: TOBII AB, DANDERYD (SE)

(72) Inventor: MAGNUS IVARSSON, DANDERYD (SE)

(21) Appl. No.: 18/369,849

(22) Filed: Sep. 19, 2023

(30) Foreign Application Priority Data
Sep. 28, 2022 (SE) 2251116-6

(51) Int. Cl. G06T 7/207; G06T 7/13; G06T 7/246

(52) U.S. Cl. CPC G06T 7/207; G06T 7/13; G06T 7/248; G06T 2207/10016; G06T 2207/20016; G06T 2207/30201

(57) ABSTRACT

A system for tracking a body part of an animal, the system comprising: an image sensor; and a controller in communication with the image sensor; wherein the controller is configured to obtain from the image sensor first and second image segments acquired by the image sensor at the same time; wherein the first image segment is acquired by the image sensor at a first resolution and the second image segment is acquired by the image sensor at a second resolution; wherein the first image segment is smaller than the full sensor image size corresponding to the full field of view of the image sensor, and has a location and size corresponding to the image of the body part within the field of view in the image plane of the image sensor; wherein the first resolution is higher than the second resolution.

### CROSS-REFERENCE TO RELATED APPLICATION

The present application claims priority to Swedish patent application No. 2251116-6, filed on Sep. 28, 2022, entitled “Image Acquisition with Dynamic Resolution,” and is hereby incorporated by reference in its entirety.

### TECHNICAL FIELD

The present disclosure relates to image acquisition with dynamic resolution, and to tracking of body parts of an animal. Example applications include detection of eye gaze, head pose, facial expression, body pose, etc. of humans, primates, and other animals.

### BACKGROUND

Interaction with computing devices is a fundamental action in today's world. Computing devices, such as personal computers, tablets, smartphones, are found throughout daily life. In addition, computing devices that are wearable, such as wearable headset devices (e.g., virtual reality headsets, augmented reality headsets, mixed reality headsets and other extended reality headsets) are becoming more popular. The systems and methods for interacting with such devices define how they are used and what they are used for.

Advances in body part tracking technologies, such as eye tracking technology and head pose tracking technology, have made it possible to interact with a computing device using a person's body movements. For example, a person's gaze information, specifically the location on a display the user is gazing at, may be used. This information can be used for interaction solely, or in combination with, a contact-based interaction technique (e.g., using a user input device, such as a keyboard, a mouse, a touch screen, or another input/output interface).

Generally, body part tracking techniques rely on continuously capturing images of the body part using an image sensor and analysing the images to extract information about the position and movement of the body part being tracked. Machine learning techniques, in particular Deep Learning, have been deployed for extracting such information from captured images.

The accuracy of body part tracking, however, depends on the quality of the images. In general, images of high resolution are desirable and improve the accuracy of information extraction. Furthermore, in some usage, a high frame rate is desirable or necessary for tracking fast-moving body parts. For example, in some applications, a frame rate of up to 1,200 frames per second (fps) may be desirable. However, the frame rate that is achievable may be limited by the data bandwidth of the communication link between the image sensor and the processor. That is, for a given image resolution, the available bandwidth may impose a minimum image readout time, which in turn limits the frame rate. Frame rate can generally be increased but given a fixed amount of bandwidth, only at the expense of image resolution. Accordingly, there exists a trade-off between image resolution and frame rate.

Furthermore, a long readout time may be undesirable as it has a direct impact on body part tracking latency.

In addition, to the extent that the trade-off could be addressed by increasing the amount of bandwidth, processing a larger flux of image data increases the power consumption of body part tracking systems.

### SUMMARY

The present invention is defined in the claims.

According to the present invention, there is disclosed a system for tracking a body part of an animal, the system comprising: an image sensor; and a controller in communication with the image sensor; wherein the controller is configured to obtain from the image sensor first and second image segments acquired by the image sensor at the same time; wherein the first image segment is acquired by the image sensor at a first resolution and the second image segment is acquired by the image sensor at a second resolution; wherein the first image segment is smaller than the full sensor image size corresponding to the full field of view of the image sensor, and has a location and size corresponding to the image of the body part within the field of view in the image plane of the image sensor; wherein the first resolution is higher than the second resolution.

The controller may be configured to obtain each of the image segments by: sending a signal to the image sensor, the signal specifying the a boundary of the respective image segment; and receiving image data from the image sensor, the image data representing the image captured within the boundary of the respective image segment at the required resolution.

The first resolution may be the maximum resolution of the image sensor.

The second image segment may be smaller than the full sensor image size.

The second image segment may have a location and size corresponding to the image of a second body part of the animal within the field of view in the image plane of the image sensor.

The first body part may be a part of the second body part.

The first body part may be an eye, and optionally the second body part is a face.

The controller may be configured to obtain a further image being an image of the full field of view of the image sensor at a resolution lower than the second resolution.

The controller may be configured to obtain one or more further image segment at one or more further resolution intermediate the first and second resolutions.

The controller may be configured to obtain a plurality of image frames in sequence. The controller may determine the location and/or size of at least one of the image segments in a given image frame based on the respective image segment obtained in one or more preceding image frame.

The controller may be configured to determine the location and/or size of the respective image segment by predicting the location and/or size of the image of the respective body part in a given image frame based on the image of the respective body part in one or more preceding image frame.

The controller may be configured to set the size of the respective image segment in a given frame by adding a predetermined margin around the image of the respective body part in one or more preceding image frame.

According to the present invention, there is disclosed a method of tracking a body part of an animal, the method comprising: obtaining from an image sensor first and second image segments acquired by the image sensor at the same time, wherein the first image segment is acquired by the image sensor at a first resolution, and the second image segment is acquired by the image sensor at a second resolution; wherein the first image segment is smaller than the full sensor image size corresponding to the full field of view of the image sensor, and has a location and size corresponding to the image of the body part within the field of view in the image plane of the image sensor; wherein the first resolution is higher than the second resolution.

Each of the image segments may be obtained by: sending a signal to the image sensor, the signal specifying the boundary of the respective image segment; and receiving image data from the image sensor, the image data representing the image captured within the boundary of the respective image segment at the required resolution.

The first resolution may be the maximum resolution of the image sensor.

The second image segment may be smaller than the full sensor image size.

The second image segment may have a location and size corresponding to the image of a second body part of the animal within the field of view in the image plane of the image sensor.

The first body part may be a part of the second body part.

The first body part may be an eye, and optionally the second body part is a face.

The method may further comprise obtaining a further image being an image of the full field of view of the image sensor at a resolution lower than the second resolution.

The method may further comprise obtaining one or more further image segment (33) at one or more further resolution intermediate the first and second resolutions.

The method may further comprise: obtaining a plurality of image frames in sequence, and determining the location and/or size of at least one of the image segments in a given image frame based on the respective image segment obtained in one or more preceding image frame.

The method may further comprise determining the location and/or size of the respective image segment by predicting the location and/or size of the image of the respective body part in a given image frame based on the image of the respective body part in one or more preceding image frame.

The method may further comprise setting the size of the respective image segment in a given frame by adding a predetermined margin around the image of the respective body part in one or more preceding image frame.

According to the present invention, there is also disclosed a computer program product comprising instructions which, when executed on a processor, cause the processor to perform the above method.

The computer program product may comprise a non-transitory computer-readable medium storing the instructions.

### FIGURES

FIG. 1 illustrates a general arrangement of a body part tracking system.

FIG. 2 illustrates an example of an arrangement of image segments within a full sensor image size.

FIG. 3 illustrates a strategy for determining a boundary of an image segment in a next image frame.

FIG. 4 illustrates another strategy for determining a boundary of an image segment in a next image frame.

FIG. 5 illustrates determining a size of an image segment in a next image frame.

FIG. 6 is a flowchart illustrating a method of body part tracking.

### DETAILED DESCRIPTION

The present disclosure is directed to tracking a body part of an animal. Various body parts may be tracked. Non-limiting examples include eye tracking, head pose tracking, body pose tracking, limb movement tracking, hand tracking, and tracking various facial features for detecting facial expression.

The term eye tracking as used herein may be understood as comprising tracking or observing actual parts of an eye, in the real world, in a 3D model of the eye, in a 2D image depicting the eye; or determining what the eye is tracking or gazing towards. Determination of what the eye is tracking or gazing towards may also be referred to as gaze tracking.

Other examples of body part tracking may include tracking hand gestures. This may involve tracking the position and movement of the hand, and tracking how these relate to the shape of the arm, for example. As another example, detecting facial expression may involve tracking the lips.

The body part being tracked may be that of a human. In particular, the embodiments of the present teachings may be useful to humans as a way of controlling a device or may be used to track how a human interacts with a system (e.g., tracking where on a computer display or a headset the human is looking at). However, the present teachings may equally be applied to tracking of body parts of other primates, and other animals in general. For example, the present teachings may be applied to observing the behaviour of different animals.

Although some passages in the present disclosure use eye tracking as an example, it is to be understood that the teachings of the present disclosure apply equally to tracking other body parts of an animal. In the present disclosure, any reference to a single eye is of course equally applicable to the any of the subject's eyes and may also be applied to both the eyes of the subject in parallel, or consecutively. As well, several different body parts may be tracked at the same time. For example, eyes and lips may be tracked in parallel.

Throughout the present disclosure, references to obtaining data may be understood as receiving data, in a push fashion, and/or retrieving data, in a pull fashion.

As noted above, generally, there exists a trade-off between image resolution and frame rate for a given communication link with a certain amount of data bandwidth. The trade-off could be addressed by providing a communication link which can accommodate a larger flux of image data resulting from a combination of a higher image resolution and/or higher frame rate. In this approach, a communication link with a large data bandwidth would be necessary.

In addition, a long readout time may increase the latency in body part tracking. That is, the time it takes for light emanating from the body part to be transformed into image data ready to be processed may contribute to a greater latency.

At the same time, when the captured images are processed, certain segments within the images may be downscaled whilst other segments may retain their original full resolution. This is because successful tracking of the body part may not require all parts of the image to be at a high resolution, as certain parts of the image may contain little relevant information for the purpose of tracking the body part. For example, in eye gaze tracking, whereas a high resolution may be desirable for the pupil/iris region, a lower resolution may be acceptable for the wider eye or face region without negatively affecting the tracking accuracy. This is especially relevant when information extraction is performed by a machine learning module, where reducing the amount of input data is generally desirable as it would reduce the complexity of the module and the amount of processing capacity required to execute the machine learning module and any image processing modules, and/or allow the tracking to be performed at a higher frame rate.

Nevertheless, since any downscaling is performed by the processor, it is still necessary to transmit the raw image data from the image sensor at full resolution and at the required frame rate. As a result, a high bandwidth communication link must still be provided between the image sensor and the processor. However, implementing a communication link with a large data bandwidth can be technically complex and costly. Furthermore, transmitting a large flux of image data requires a large amount of processing capacity, and thus electrical power. Also, the readout time is not reduced and its contribution to latency is not reduced.

The present disclosure recognises that the flux of image data could be reduced without negatively affecting body part tracking accuracy and performance. Furthermore, reducing the flux of image data may also reduce power consumption.

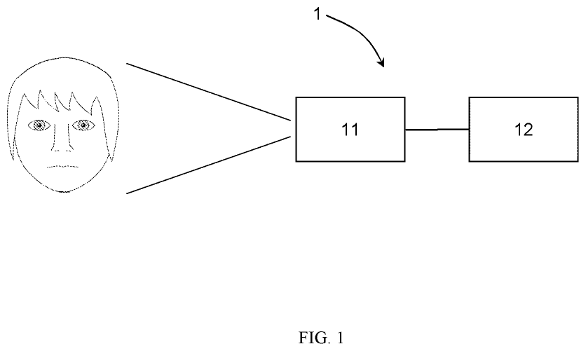

FIG. 1 shows the general arrangement of a system for tracking a body part of an animal. As shown, the system 1 includes an image sensor 11 and a controller 12. The controller 12 is in communication with the image sensor 11. As shown, the image sensor 11 has a field of view, and a human face is shown to be falling within the field of view of the image sensor 11. Of course, as noted above, other parts of a human, or of another animal, may be tracked, and a human face is used here as an example only.

The image sensor may be configured to capture image data suitable for the body part of the animal to be tracked. The image sensor 11 may, for example, be a camera, such as a complementary metal oxide semi-conductor (CMOS) camera, or a charged coupled device (CCD) camera. The image sensor 11 may capture images in the visible spectrum, and/or parts of the spectrum outside the visible range. For example, the image sensor 11 may capture infrared (IR) images. The image sensor 11 may alternatively or additionally capture other information such as depth, the phase of the light rays, and the directions of incident light rays. For example, the image sensor 11 may comprise a depth camera, and/or a light-field camera. The image sensor 11 may employ different shutter mechanisms, such as a rolling shutter or a global shutter.

The image sensor 11 may be commanded to acquire image segments at different resolutions. This may be achieved in different ways. For example, if the image sensor has a rectilinear array of pixels at a native resolution, a lower resolution may be achieved by combining the signals of every four pixels in a 2×2 array into a single signal. A yet lower resolution may be achieved by combining every 9 pixels in a 3×3 array into a single signal, for example. The combining of pixels may be achieved by averaging the signals of the pixels.

Another approach of acquiring image segments at a resolution which is lower than the native/full resolution of the image sensor 11 may be to poll only a subset of pixels. That is, signals are received from some, but not all, of the pixels. The pixels being polled may form a regular lattice. For example, one pixel in every two columns and every two rows may be polled.

The two approaches above may be used in conjunction. That is, a subset of pixels may be polled, and, within that subset, regular arrays of pixels may be combined. For example, 2×2 arrays of pixels located every three rows and every three columns may be polled, and each 2×2 array of pixels may be combined into one signal.

The resolution in the vertical direction and the resolution in the horizontal direction need not be equal. For example, a lower resolution may be achieved by combining every two neighbouring pixels (i.e., a vertical or horizontal 2×1 array) into one signal. This may be useful in achieve a resolution between the full resolution and combining every 2×2 array into one signal. More generally, further intermediate resolutions can be achieved by combining rectangular arrays of pixels (e.g., every six pixels in a 3×2 array) into one signal. Similarly, where a subset of pixels is polled, the lattice of the polled pixels need not be square and may have different resolutions in the horizontal and vertical directions.

Furthermore, it is to be understood that the present disclosure is not limited to image sensors with a rectilinear or square array of pixels. For example, the image sensor 11 may have a hexagonal array of pixels, and the resolution of an image segment may be adjusted by combining the native pixels according to an appropriate pattern.

In general, the image sensor 11 may be capable of acquiring image segments at the required resolutions without performing downscaling. In other words, the image segment may be acquired directly at the commanded resolution. That is, when the image sensor 11 is commanded to acquire an image segment at a resolution which is lower than the full/native resolution, the image sensor does not first acquire the image segment at the full/native resolution and then subsequently downscale the image segment to the commanded resolution.

The controller 12 may communicate with the image sensor 11 via a communication link. The communication link may be configured to transmit digital data. In particular, the communication link may enable the controller 12 to obtain image data from the image sensor 11. The communication link may also enable the controller 12 to transmit commands to the image sensor 11. Although shown as a solid line in FIG. 1, the communication link is not limited to a wired connection. The communication link may be implemented as a wireless connection, which may enable greater flexibility of the placement of the controller 12 in relation to the image sensor 11. The communication link may also comprise a mixture of one or more wired section and one or more wireless section. Irrespective of the configuration, the communication link may provide adequate data bandwidth for the controller 12 to obtain image data from the image sensor 11 at the necessary image resolutions and frame rates.

The controller 12 may comprise one or more processors and may comprise computer memory. The controller 12 may be implemented by generic computing means or by dedicated hardware. For example, the controller 12 may be a desktop computer, a laptop computer, a smart phone, or a tablet, and the like. The image sensor 11 may be provided integrally with the controller 12 or may be provided externally to the controller 12. For example, the image sensor 11 may be a camera of a smart phone, where the smart phone serves as the controller 12. In other examples, the image sensor 11 may be part of a virtual reality headset, augmented reality glasses, a remote eye tracking system, or a car driver monitoring system. The image sensor 11 and the controller 12 may also be implemented on a single printed circuit board, or on a single semiconductor chip.

The controller 12, in addition to communicating with the image sensor 11, may implement further functions. For example, the controller 12 may be configured to analyse images obtained from the image sensor 11. For example, the controller 12 may implement a machine learning module, such as a deep learning module, for analysing the images. The machine learning module may extract information from the images, such as using digital image processing. The output of the machine learning module may, in turn, be used by the controller 12 for generating commands to be sent to the image sensor 11.

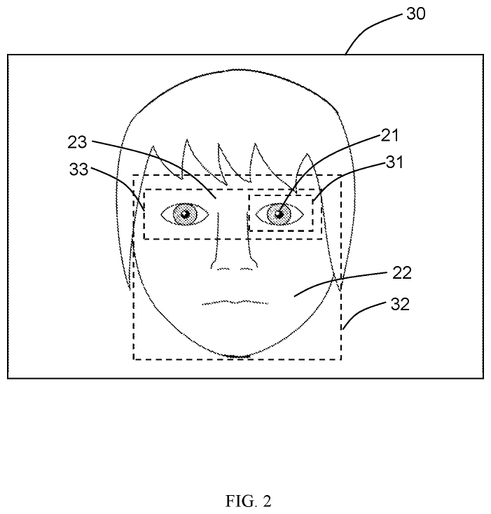

FIG. 2 shows an example of how image data is obtained. FIG. 2 shows the full extent of the image that can be captured by the image sensor 11. This is referred to as the full sensor image size 30. It corresponds to the full field of view of the image sensor 11.

As shown in FIG. 2, as an example, a human face falls within the full field of view of the image sensor 11. However, it is to be understood that the content falling within the full sensor image size 30 is shown here for illustrative purposes only; it does not imply that the entire content falling within the full sensor image size 30 is captured by the image sensor 11, or indeed obtained by the controller 12 or any downstream component.

Image segments may be obtained at specific resolutions. An image segment may be obtained from the image sensor 11 by transmitting a command to the image sensor 11. The command may be transmitted by the controller 12. The command may include a specification of the boundary of the image segment, and/or may include a specification of the resolution at which the image segment is to be acquired. Correspondingly, the image sensor 11 may be configured to accept commands from the controller 12. The image sensor 11 may be configured to accept commands including a specification of the boundary of an image segment and/or a resolution at which the image segment is to be acquired. The command may include a specification of more than one such image segment.

The image sensor 11 acquires a first image segment 31 at a first resolution. The first image segment 31 is obtained by the controller 12. When obtaining the first image segment 31, image data representing the first image segment 31 may be transmitted via the communication link between the image sensor 11 and the controller 12. The first image segment 31 may be obtained without also obtaining the rest of the content falling within the full sensor image size 30. That is, if the command is to obtain the first image segment 31 only, then the image data transmitted from the image sensor 11 may include image data corresponding only to image segment 31, and image data representing image content outside the first image segment 31 is therefore not transmitted. The ability to obtain an image segment without transmitting image data for the entire content within the full sensor image size 30 may help to reduce the amount of data that needs to be transmitted and therefore reduce the demand on data bandwidth on the communication link between the image sensor 11 and the controller 12. It may also reduce the readout time, and hence latency.

More than one image segment is obtained at a time. A second image segment 32 is obtained from the image sensor at the same time as obtaining the first image segment 31. The second image segment 32 is acquired at a second resolution by the image sensor 11. The second resolution is different from the first resolution. In other words, the image sensor 11 may be capable of dynamic resolution. That is, the image sensor 11 may be capable of acquiring different image segments at different corresponding resolutions as required.

The image sensor 11 acquires the first and second image segments 31, 32 at, respectively, the first and second resolutions at the same time. That is, the image sensor 11 may acquire both the first and second image segments 31, 32 in a single image frame, so that the first and second image segments 31, 32 are not separated by a time delay.

Acquiring the first and second image segments 31, 32 in this manner may avoid or reduce motion artefacts. By contrast, if the first and second image segments 31, 32 are acquired one after the other with a time delay, due to motion of the body parts, the content within the first and second image segments 31, 32 may give the impression that there has been relative movement between the imaged body parts when, in reality, there was no relative movement. For example, if an image segment of an eye and an image segment of the entire face are acquired at slightly different times, a lateral movement of the face could be misinterpreted as a rotation of the face. Therefore, by acquiring the image segments at the same time, motion artefacts of this type may be avoided or reduced.

As shown in FIG. 2, the first image segment 31 is smaller than the full sensor image size 30. The first image segment 31 has a location and size corresponding to the image of a body part 21 within the field of view within the image plane of the image sensor 11. As shown in FIG. 2, as an example, the first image segment 31 is located at the image of an eye and has a size which corresponds to the image of the eye.

Furthermore, the first resolution (at which the first image segment 31 is acquired) is higher than the second resolution (at which the second image segment 32 is acquired). In the example shown in FIG. 2, it may be advantageous to acquire the first image segment 31 at a relatively high resolution because high resolution details of the iris/pupil may enable accurate determination of a gaze angle of the eye. The second image segment 32 may be advantageously acquired at a relatively low resolution if the fine image details are less critical for the accurate tracking of the body part. By acquiring the second image segment 32 at a lower resolution than the first resolution, the amount of image data to be transmitted from the image sensor may accordingly be reduced.

Overall, by reserving a high resolution to an image segment in which fine image details are critical to the accurate tracking of a body part, and by allowing another image segment to be acquired at a lower resolution, the body part may be accurately tracked whilst reducing the data bandwidth required. Alternatively, given a fixed amount of data bandwidth, a shorter readout time and a higher framerate and/or lower latency can be achieved.

As noted above, an image segment may be obtained by sending a command to the image sensor 11. Several image segments may be obtained similarly. That is, a single command transmitted to the image sensor 11 may include specification of the boundaries of each of the first and second image segments 31, 32. The command may also include a specification of the first and second resolutions, at which the first and second image segments 31, 32 are to be acquired. Alternatively, the first and second resolutions may be fixed or predetermined, so that the command need not include a specification of the resolutions. In general, a single command may include the specification of any number of image segments, including the respective boundaries and respective resolutions. The controller 12 may be configured to transmit such a command.

Image data representing the image captured within the boundary of the respective image segment 31, 32 at the required resolution may be received from the image sensor 11. The image data may be transmitted via the communication link between the image sensor 11 and the controller 12. The first and second image segments 31, 32 may be obtained without also obtaining the rest of the content falling within the full sensor image size 30. That is, if the command is to obtain the first and second image segments 31, 32 only, then the image data transmitted from the image sensor 11 may include image data corresponding only to the image segments 31, 32, and data representing image content outside both the first and second image segments 31, 32 is therefore not transmitted. An exception is when the second image segment 32 covers the full sensor image size 30, in which case the transmitted image data would cover the full image falling within the full sensor image size 30.

Generally, the image data transmitted from the image sensor 11 may include only image data representing the commanded image segments, and not include data representing image content not falling within at least one of the commanded image segments. As noted above, the ability to obtain image segments without transmitting image data for the entire content within the full sensor image size 30 may help to reduce the amount of data that needs to be transmitted and therefore reduce the demand on data bandwidth on the communication link between the image sensor 11 and the controller 12.

The first resolution, at which the first image segment is acquired by the image sensor 11, may be the maximum resolution of the image sensor 11. This may enable the maximum amount of information to be extracted from the first image segment 31. For example, in eye tracking, it may be advantageous to acquire the image of the iris/pupil at the maximum available resolution as this may improve the accuracy of the determination of eye gaze.

As noted above, the entire human face is depicted in FIG. 2 but this does not imply that the entire image content within the full sensor image size 30 is acquired, or that image data thereof is transmitted. As shown in FIG. 2, the second image segment 32 may also be smaller than the full sensor image size 30. As noted above, the first resolution is higher than the second resolution. The second image segment 32, acquired at the lower resolution, may enable a second body part to be tracked. The second body part may be a body part which may be accurately tracked without requiring the higher resolution of the first image segment 31.

For example, as shown in FIG. 2, the image of the second body part 22 may correspond to the face. Compared with an eye, the position and movements of a face may be accurately tracked without requiring high-resolution image details. As with the first image segment 31, the second image segment 32 may have a location and size corresponding to the image of the second body part. For example, the second image segment 32 may have a location centred at the image of the second body part 22, and/or may have a size large enough to cover the image of the second body part 22. In the example shown in FIG. 2, the second image segment 32 may be located and sized to cover the image of the face.

The first and second image segments 31, 32 may then be passed on to another element of the system for analysis. For example, the image segments may be analysed by a machine learning module (not shown). For example, using the examples shown in FIG. 2, a high-resolution image segment of the eye together with a lower resolution image segment of the face may be passed onto a machine learning module for the detection of eye gaze and/or head pose. Before being input to a machine learning module, the image segments may be cropped and/or resampled as required. For example, cropping and/or resampling may be performed so as to match the size and/or resolution of the images on which the machine learning module was trained. As noted above, the controller 12 may, in addition to communicating with the image sensor 11, also be configured to analyse the image segments. Specifically, the controller 12 may implement a machine learning module, such as a deep learning module. In this case, the image segments 31, 32 may be obtained from the image sensor 11 by the controller 12 and be analysed by the same controller 12.

In general, the different body parts captured by different image segments need not be connected or related and may be disparate and unconnected. However, it may be advantageous in certain situations for the different imaged body parts to be related. In particular, certain types of body part tracking requires that one of the imaged body parts is part of another body part.

For example, the first body part may be part of the second body part. In the example shown in FIG. 2, the eye may be the first body part, and the face may be the second body part. In this example, the first body part is part of the second body part because the eye is a part of the face. In this example, the tracking of eye gaze may also take into account the head pose.

In the above example, the first body part is entirely within the second body part. However, the first body part may be part of the second body part without being entirely within the second body part. By way of an example not shown in the figures, the first body part may be a hand and the second body part may be the limb including the hand and the arm to which the hand is attached. In this example, the hand is a part of the limb even though, in some sense, the hand is not within the limb.

As yet another example, the first body part may be an ear, and the second body part may be a face. In this example, the ear can be said to be part of the face but, at least from a front view of the face, the image of the ear may lie completely outside the image of the face.

Therefore, depending upon the choice of the first and second body parts, the first and second image segments 31, 32 may have varying degrees of overlap, or even no overlap at all. For example, the second image segment 32 may be completely encompassed by the boundary of the first image segment 31. Alternatively, the first and second image segments 31, 32 may partially overlap (in other words, intersect). The first and second image segments 31, 32 may have no overlap at all.

Where the image segments overlap, the image data representing the overlapping portion may advantageously be transmitted from the image sensor 11 only once. Using FIG. 2 as an example, because the first image segment 31 is entirely encompassed within the second image segment 32, the image data representing the second image segment 32 may omit the region covered by the first image segment 31.

In more general terms, any of the image segments may contain holes or cut-outs, i.e., regions in which image data is omitted. By ensuring that image data is not duplicated, the amount of data to be transmitted from the image sensor 11 may be further reduced.

Furthermore, although the image segments are shown to be rectangular in the figures, it is to be understood that the image segments may be of other shapes. For example, the image segments may be circular or oval. The image segments may have a mixture of shapes as required, depending on the body part. For example, the image segment 31 for an eye may be oval, so as to approximate the shape of an eye. Of course, the shape of an image segment need not be horizontal or vertical; it may be angled. For example, the shape of an image segment for an upper arm may be an elongate rectangle which is angled to match the orientation of the upper arm.

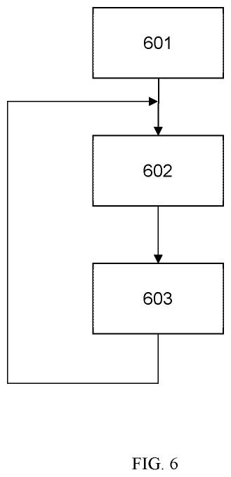

In addition to obtaining image segments, a further image of the full field of view of the image sensor 11 may be obtained (step 601 in FIG. 6). That is, an image covering the full sensor image size 30 may be obtained. Such an image may be usefully obtained before body part tracking commences, for example. Such an image may allow required location and/or size of the different image segments to be determined before body part tracking begins. For example, the image may be analysed to identify at least the initial location and size of each body part to be tracked within the image. The analysis may be performed using a machine learning module. The analysis may be performed by the controller 12.

The image covering the full sensor image size 30 may not require a high resolution. For example, the resolution of this image may be lower than the second resolution. This is because the initial size and location of the relevant body parts may be identifiable without needing fine image details. For example, in order to determine the initial location and size of an eye, it may not be necessary to employ the same high resolution as required for extracting details of the iris/pupil. Furthermore, this image, which covers the full sensor image size 30, may be obtained only before body part tracking commences, and not during body part tracking.

Although the above disclosure refers to first and second image segments 31, 32, the present disclosure is not limited to obtaining two image segments. As shown in FIG. 2, a further image segment 33 may be obtained from the image sensor 11. The further image segment 33 may be obtained at a further resolution which is intermediate the first and second resolutions. In the example shown in FIG. 2, the further image segment 33 has a location and size corresponding to the image of the eye area 23. As shown, the further image segment 33 covers both eyes and a part of the nose bridge. In other words, in the example shown in FIG. 2, the first image segment 31 (covering an eye) may be at a relatively high resolution, the second image segment 32 (covering the face) may be at a relatively low resolution, and the further image segment 33 (covering the eye area) may have an intermediate resolution. Such an arrangement may allow different regions of the face (including the eyes) to be accurately tracked using image data with a dynamic resolution which is appropriate for the respective regions. The use of dynamic resolutions may allow the overall flux of image data to be reduced without degrading the accuracy or performance of body part tracking.

It is to be understood that more than three image segments may be obtained from the image sensor 11. Depending on the complexity of the body part and/or the tracking arrangement, the number of image segments and their corresponding resolutions may be selected as required.

During body part tracking, the body part being tracked may not remain stationary within the field of view of the image sensor 11. It is often the case the body part being tracked will move within the field of view of the image sensor 11. Furthermore, in addition to moving laterally within the field of view of the image sensor 11, the body part may also move closer to or away from the image sensor, causing its apparent size to change. Therefore, the image of the body part may change location and/or size within the field of view of the image sensor 11. Accordingly, it may be advantageous to adjust the boundaries of the image segments over time, so as to accommodate movements of the body part being tracked.

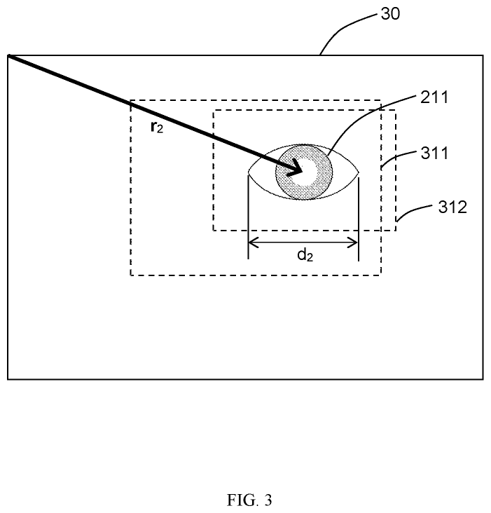

Referring now to FIG. 3, the controller 12 may be configured to obtain a plurality of image frames in sequence. Corresponding image segments may be obtained in each of the plurality of image frames (step 602 in FIG. 6). For example, the first image segment 31 mentioned above may be obtained in first and second image frames, labelled in FIG. 3 respectively as 311 and 312. For the purpose of illustration, the first image frame may be considered to be an image frame already obtained, and the second image frame may be considered to be the next image frame to be obtained. As shown, the image of the body part in the first frame 211 is shown to be within the boundary of the first image segment in the first frame 311. Using this information, the boundary of the first image segment in the second frame 312 may be determined (step 603 in FIG. 6). For example, the location and/or size of the first image segment in the second frame 312 may be determined from the first image segment in the first frame 311. Depending on the movement of the body part, the first image segment in the first and second frames 311, 312 may have different locations and/or sizes.

Different strategies for determining the boundary of an image segment in a next frame are possible.

A general strategy may involve attempting to keep the image of the body part being tracked at the centre of the image segment. The image segment may be sized to be large enough to encompass the image of the body part being tracked.

In the example shown in FIG. 3, the image of the body part in the first frame 211 (the reference sign 211 here refers to the image; reference signs 210 and 212 below similarly refer to images of the body part in the respective image frames) appears to be offset to one side of the first image segment in the first frame 311. In simple terms, one possible strategy is to set the location and/or size of the first image segment in the second frame 312 to correspond to the location and/or size of the image of the body part in the first frame 211.

More specifically, the centre location of the image of the body part in the first frame 211 may be determined. The centre location of the image of the body part in the first frame 211 may serve as the centre location r₂ (bold type indicates vectors) of the first image segment in the second frame 312. The size d₂ of the image of the body part in the first frame 211 may be determined. In turn, the size of the first image segment in the second frame 312 may be determined based on the size d₂ of the image of the body part in the first frame 211. Although the size d₂ of the image of the body part in the first frame 211 is shown as the horizontal width of an eye, the height of the eye may additionally or alternatively be determined and be used to determine the size of the first image segment in the second frame 312. Depending on the body part to be tracked, other definitions of size can be used. For example, instead of height and width, the size of the image of a body part may be determined in terms of the radius of a circle.

The above example may be understood as a relatively straightforward strategy for determining the boundary of an image segment in the next frame. It has the advantage of being simple to implement and requiring few computing resources.

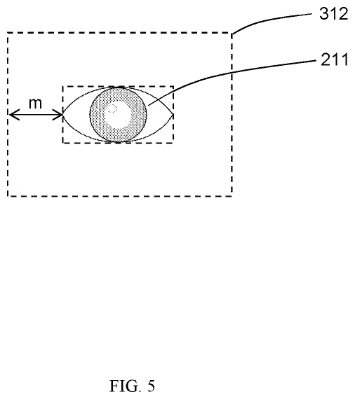

It is to be understood that the movement of the body part may be sporadic and unpredictable. Therefore, the size and location of the image of the body part generally cannot be predicted with certainty. As such, in order to accommodate the uncertainty of the body part being tracked, as shown in FIG. 5, the boundary of the respective segment in the next frame may be determined by setting it to be larger than the image of the body part in the current frame. As shown, the boundary of the first image segment in the second frame 312 may be determined by adding a predetermined margin m around the image of the body part in the first frame 211. The extent of the image of the body part 211 may be determined by a processor, for example that of the controller 12. The determination of the extent of the image of the body part 211 may be determined using a machine learning module, for example the same or a different machine learning module that is used to track the body part.

Referring back to FIG. 3, although the relatively simple strategy involves assuming that the location of the image of the body part in the second frame 212 (not shown in FIG. 3) will be the same as the location of the image of the body part in the first frame 211, by sizing the first image segment in the second frame 312 to include a margin m around the image of the body part in the first frame 211, even if the image of the body part shifts to a different location in the second frame, it is likely that the image of the body part in the second frame 212 will still fall within the boundary of the first image segment in the second frame 312. In this case, in the second image frame, the image of the body part will be skewed to one side within the first image segment in the second frame 312, just like the image of the body part in the first frame 211 is skewed to one side within the first image segment in the first frame 311. The boundary of the first image segment in the third frame (not shown) may therefore be determined based on the first image segment in the second frame 312 in the same way that the boundary of the first image segment in the second frame 312 can be determined from the first image segment in the first frame 311. The boundary of the first image segment in subsequent frames may be similarly determined. More generally, as shown in FIG. 6, the obtained image segments may be used to determine the boundaries of image segments in the next frame, and the process may repeat indefinitely for as long as body part tracking is required. Using this arrangement, the boundary of the first image segment 31 may be continually adjusted to accommodate the movement of the first body part.

Although the example shown in FIG. 3 shows how the boundary of the first image segment 311, 312 may be adjusted over time, it is to be understood that the second image segment 32 and any further image segments may also be similarly adjusted over time to accommodate the movement of the respective body parts.

The relatively simple strategy above uses one preceding image frame to determine the boundaries of the image segments in the next image frame. However, for improved accuracy, more than one preceding image frame may be used in the determination of the boundaries of the image segments in the next image frame.

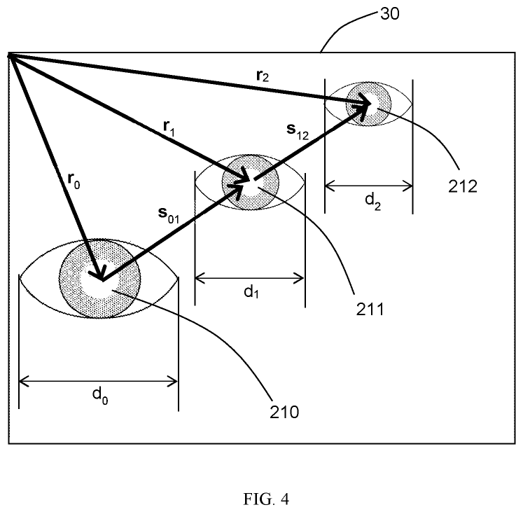

FIG. 4 shows an approach of determining the boundary of an image segment in the next frame based on the image segment in two preceding frames. FIG. 4 shows the image of a body part in a zeroth frame 210, in a first frame 211, and in a second frame 212. As shown, for illustrative purposes, the image of a body part changes in location and size through the image frames. Using the image of the body part in the zeroth and first frames 210, 211, the size and/or location of the image of the body part in the second frame 212 can be predicted. For example, the location r₀ and size d₀ of the image of the body part in the zeroth frame 210 can be determined. The location r₁ and size d₁ of the image of the body part in the first frame 211 can also be determined. The change in location in the image of the body part between the zeroth and first frames may be determined as s₀₁=r₁−r₀. The location r₂ and size d₂ of the image of the body part in the second frame 212 may be estimated from s₀₁, d₀ and d₁.

The size of the image of the body part may be assumed to change geometrically. That is, it may be assumed that d₁/d₀=d₂/d₁. This approach assumes that the body part is moving away from (or closer to) the image sensor at a constant speed.

For location estimation, it may simply be assumed that the change in location of the image of the body part s₁₂ between the first and second frames is the same as the change between the zeroth and first frames s₀₁. Accordingly, the estimated location r₂ of the image of the body part in the second frame 212 may be calculated by adding s₁₂ to r₁. This approach of location estimation does not take into account the effect of perspective but has the advantage of being simple to implement. Furthermore, if the frame rate is high enough relative to the speed of movement of the body part, the effect of perspective may be negligible.

The location estimation may be improved by also taking into account the effect of perspective. For example, the location estimation may include the size of the image of the body part d₀, d₁ in the zeroth and first image frames as input parameters. Specifically, the change in location of the image of the body part between the first and second image frames 211, 212 may be estimated as s₁₂=(d₁/d₀) s₀₁. The location r₂ of the image of the body part in the second frame 212 may thus be estimated as r₂=r₁+s₁₂.

Using the estimated size d₂ and/or location r₂ of the image of the body part in the second frame 212, a suitable boundary for the first image segment in the second frame 312 (not shown in FIG. 4) may be determined as above, for example by adding a predetermined margin m around the estimated image of the body part in the second frame 212.

The above prediction strategy takes into account the speed of the movement of the body part being tracked.

It is to be understood that other strategies may use a greater number of image frames. For example, by using three preceding image frames, it is possible to take the acceleration of the body part into account.

An advantage of using several preceding image frames in the prediction is that the location and/or size of the image of the body part can be predicted with greater accuracy. Accordingly, a smaller margin m may be applied so that the image segment is sized more tightly around the image of the body part. This may further reduce the amount of data to be transmitted from the image sensor 11.

Furthermore, although some of the strategies above use a constant predetermined margin m, the width of the margin m need not be constant and may be variable. For example, the amount of margin m may scale linearly with the size of the image of the body part d₀, d₁, d₂. The scaling of m may be subject to predetermined maximum and/or minimum limits.

Although, in the simplest case, the resolution of an image segment may remain constant from frame to frame, the image resolution of the image segment may also be variable. For example, if the body part is close to the image sensor, such that the image of the body part is large, the image segment covering the body part may switch to a lower resolution compared with when the body part is far away from the image sensor. That is, image resolution may be adjusted dynamically in response to the distance of the body part. This may allow the same amount of details and information to be extracted from the image segment while reducing the amount of image data to be transmitted. For example, the resolution of an image segment may be inversely proportional to the size of the image segment.

In certain situations, it may be desirable to keep the resolution of an image segment at a fixed resolution, such as the maximum resolution of the image sensor 11. For example, it may be desirable to capture the iris/pupil always at the maximum available resolution, irrespective of its distance to the image sensor 11. For example, it may be desirable to capture certain image segments at a fixed resolution if the machine learning module has been trained to accept images of a fixed resolution.

As noted above, depending on the body parts to be tracked, image segments may have different degree of overlap, including no overlap at all. However, it is to be understood that the degree of overlap between any two image segments may change over time as the body parts move. For example, the degree of overlap between an image segment for an ear and an image segment for a head may change as the head rotates. Specifically, the degree of overlap may range from no overlap in a front view of the head, to full overlap in a side view of the head. Therefore, as a multitude of image frames are obtained during the course of body part tracking, any overlap between the image segments may change.

As noted above, the controller 12 may be implemented by general computing means, such as a desktop computer, a laptop, a smart phone, and a tablet. The controller 12 may also be implemented as dedicated hardware. The controller 12 may be part of a virtual reality headset, augmented reality glasses, a remote eye tracking system, or a car driver monitoring system, for example. Accordingly, the present disclosure includes a computer program product comprising instructions to be executed on a processor so as to cause the processor to communicate with the image sensor 11 in the various manners disclosed above. The instructions may be stored on a non-transitory computer-readable medium, such as flash memory, hard-disk drive, and optical disc.

1. A system for tracking a body part of an animal, the system comprising:
an image sensor; and
a controller in communication with the image sensor;
wherein the controller is configured to obtain from the image sensor first and second image segments acquired by the image sensor at the same time;
wherein the first image segment is acquired by the image sensor at a first resolution and the second image segment is acquired by the image sensor at a second resolution;
wherein the first image segment is smaller than the full sensor image size corresponding to the full field of view of the image sensor, and has a location and size corresponding to the image of the body part within the field of view in the image plane of the image sensor;
wherein the first resolution is higher than the second resolution.

2. The system of claim 1, wherein the controller is configured to obtain each of the image segments by:
sending a signal to the image sensor, the signal specifying a boundary of the respective image segment; and
receiving image data from the image sensor, the image data representing the image captured within the boundary of the respective image segment at the required resolution.

3. The system of claim 1, wherein the first resolution is the maximum resolution of the image sensor.

4. The system of claim 1, wherein the second image segment is smaller than the full sensor image size.

5. The system of claim 1, wherein the second image segment has a location and size corresponding to the image of a second body part of the animal within the field of view in the image plane of the image sensor.

6. The system of claim 1, wherein the controller is configured to obtain a further image being an image of the full field of view of the image sensor at a resolution lower than the second resolution.

7. The system of claim 1, wherein the controller is configured to obtain one or more further image segment at one or more further resolution intermediate the first and second resolutions.

8. The system of claim 1, wherein the controller is configured to:
obtain a plurality of image frames in sequence, and
determine a location and/or size of at least one of the image segments in a given image frame based on the respective image segment obtained in one or more preceding image frame.

9. The system of claim 8, wherein the controller is configured to determine the location and/or size of the respective image segment by predicting the location and/or size of the image of the respective body part in a given image frame based on the image of the respective body part in one or more preceding image frame.

10. The system of claim 8, wherein the controller is configured to set the size of the respective image segment in a given frame by adding a predetermined margin around the image of the respective body part in one or more preceding image frame.

11. A method of tracking a body part of an animal, the method comprising:
obtaining from an image sensor first and second image segments acquired by the image sensor at the same time, wherein the first image segment is acquired by the image sensor at a first resolution, and the second image segment is acquired by the image sensor at a second resolution;
wherein the first image segment is smaller than the full sensor image size corresponding to the full field of view of the image sensor, and has a location and size corresponding to the image of the body part within the field of view in the image plane of the image sensor;
wherein the first resolution is higher than the second resolution.

12. The method of claim 11, wherein each of the image segments is obtained by:
sending a signal to the image sensor, the signal specifying the boundary of the respective image segment; and
receiving image data from the image sensor, the image data representing the image captured within the boundary of the respective image segment at the required resolution.

13. The method of claim 11, wherein the second image segment is smaller than the full sensor image size.

14. The method of claim 11, wherein the second image segment has a location and size corresponding to the image of a second body part of the animal within the field of view in the image plane of the image sensor.

15. The method of claim 11, further comprising obtaining a further image being an image of the full field of view of the image sensor at a resolution lower than the second resolution.

16. The method of claim 11, further comprising obtaining one or more further image segment at one or more further resolution intermediate the first and second resolutions.

17. The method of claim 11, further comprising:
obtaining a plurality of image frames in sequence, and
determining the location and/or size of at least one of the image segments in a given image frame based on the respective image segment obtained in one or more preceding image frame.

18. The method of claim 17, further comprising determining the location and/or size of the respective image segment by predicting the location and/or size of the image of the respective body part in a given image frame based on the image of the respective body part in one or more preceding image frame.

19. The method of claim 17, further comprising setting the size of the respective image segment in a given frame by adding a predetermined margin around the image of the respective body part in one or more preceding image frame.

20. A non-transitory computer-readable medium storing the instructions which, when executed by a processor, causes the processor to perform the method of claim 11.
